(19) United States
(12) Patent Application Publication
(10) Pub. No.: US 2022/0261481 A1
(43) Pub. Date: Aug. 18, 2022

(54) SOFTWARE PACKER-AGNOSTIC UNPACKING OF PACKED EXECUTABLES

(71) Applicant: Palo Alto Networks, Inc., Santa Clara, CA (US)

(72) Inventor: James Thomas Fitzgerald, San Jose, CA (US)

(21) Appl. No.: 17/175,321

(22) Filed: Feb. 12, 2021

(51) Int. Cl. G06F 21/56; G06F 21/53

(52) U.S. Cl. CPC G06F 21/566; G06F 2221/033; G06F 21/53

(57) ABSTRACT

To unpack packed executables generated with a packer or packing technique that cannot be identified, a universal unpacker unpacks the executable by running the packed executable in a controlled environment and monitoring execution of the program code which unpacks the executable and memory accessed as a result. The unpacker intercepts system calls issued during execution and can allow, emulate, or block intercepted system calls to provide maximum protection of the host system on which it executes. Unpacking and monitoring can continue until a criterion for termination has been satisfied, such as whether a specified time has elapsed, a specified number of instructions have executed, or a system call which triggers termination has been intercepted. The unpacker writes the memory that comprises the unpacked executable to disk. Malware analysis can then be performed on the unpacked executable.

### BACKGROUND

The disclosure generally relates to electric digital data processing and to security arrangements for protecting computers, components thereof, programs or data against unauthorized activity.

Software packing, often referred to as executable compression, is commonly implemented to reduce sizes of executable files. A “packed” executable generally comprises compressed program code of the executable and corresponding unpacking program code. Packed executables packed in this manner are self-unpacking such that the executable is unpacked as a result of execution of the unpacking program code. Known software packers used to pack an executable can be identifiable from the resulting packed executable, though in other cases, the software packer may be unknown or undetectable from the packed executable. Software packers can also be utilized to obfuscate the contents of an executable as a result of packing. This can be advantageous for distribution of malware, as packed executables which comprise malicious code may bypass malware detection services or may be unable to be reverse engineered.

### BRIEF DESCRIPTION OF THE DRAWINGS

Embodiments of the disclosure may be better understood by referencing the accompanying drawings.

FIG. 1 depicts an example conceptual diagram of software packer-agnostic unpacking of executable files.

FIG. 2 depicts a flowchart of example operations for identifying and unpacking packed executables for malware analysis.

FIG. 3 depicts a flowchart of example operations for performing software packer-agnostic unpacking of a packed executable.

FIG. 4 depicts a flowchart of example operations for handling system calls intercepted during unpacking of a packed executable.

FIG. 5 depicts an example computer system with a packed executable detection and unpacking system.

### DESCRIPTION

The description that follows includes example systems, methods, techniques, and program flows that embody aspects of the disclosure. However, it is understood that this disclosure may be practiced without these specific details. For instance, this disclosure refers to Executable and Linkable Format (ELF) files in illustrative examples. Aspects of this disclosure can be also applied to other executable file formats, such as Portable Executable (PE) files. In other instances, well-known instruction instances, protocols, structures and techniques have not been shown in detail in order not to obfuscate the description.

### Overview

Although existing tools can detect that an executable file has been packed, malware detection services cannot determine whether the packed executable comprises malware as a result of the obfuscation caused by packing. In cases where the packed executable was generated using an unknown software packer or packing technique, the executable cannot be unpacked and thus cannot be analyzed for detection of malware. To resolve this, a “universal” unpacker described herein unpacks executables by utilizing a technique that is agnostic to the specific software packer or packing technique with which the executable file was packed. Packed executables comprising malware that may have previously been unable to be unpacked due to an inability to identify how they were packed and thus gone undetected can then be unpacked and subsequently detected as comprising malicious code. A greater number of software samples (e.g., program code detected or identified from network traffic) which comprise malware can therefore be identified as a result of this universal unpacking which effectively preprocesses packed executables to produce a format that is compatible with malware detection services.

Upon identification of an executable that has been packed, the unpacking system analyzes the packed executable to determine if the software packer or packing technique with which it was generated can be identified. If the software packer or packing technique can be identified, the unpacking system passes the packed executable to the corresponding known software unpacker and forwards the resulting unpacked executable to a malware detection service for malware analysis. If the software packer cannot be identified, the packed executable is passed to a universal unpacker. The unpacker is referred to as universal because it can unpack executables which were generated with any software packer or packing technique. The universal unpacker then unpacks the packed executable by executing the packed executable in a controlled environment, such as by loading the packed executable in a central processing unit (CPU) emulator, and monitoring execution of the program code which unpacks the executable and memory accessed as a result. Utilizing a CPU emulator for unpacking executables provides for a more lightweight solution than would result from instead utilizing a virtual machine for execution of packed executables. The universal unpacker intercepts system calls issued during execution and handles the system calls on an individual basis (e.g., by allowing, emulating, or blocking each system call) to protect the host system on which it executes. Unpacking and monitoring can continue until a criterion for termination has been satisfied, such as whether a specified time has elapsed, a specified number of instructions have executed, or a system call which triggers termination has been intercepted. Upon termination of unpacking, the universal unpacker can write the portion of memory in which the packed data of the executable has been unpacked—which comprises the unpacked executable—to disk. Malware analysis of the executable that includes static analysis and/or dynamic analysis can then successfully be performed as a result of the unpacking.

### Example Illustrations

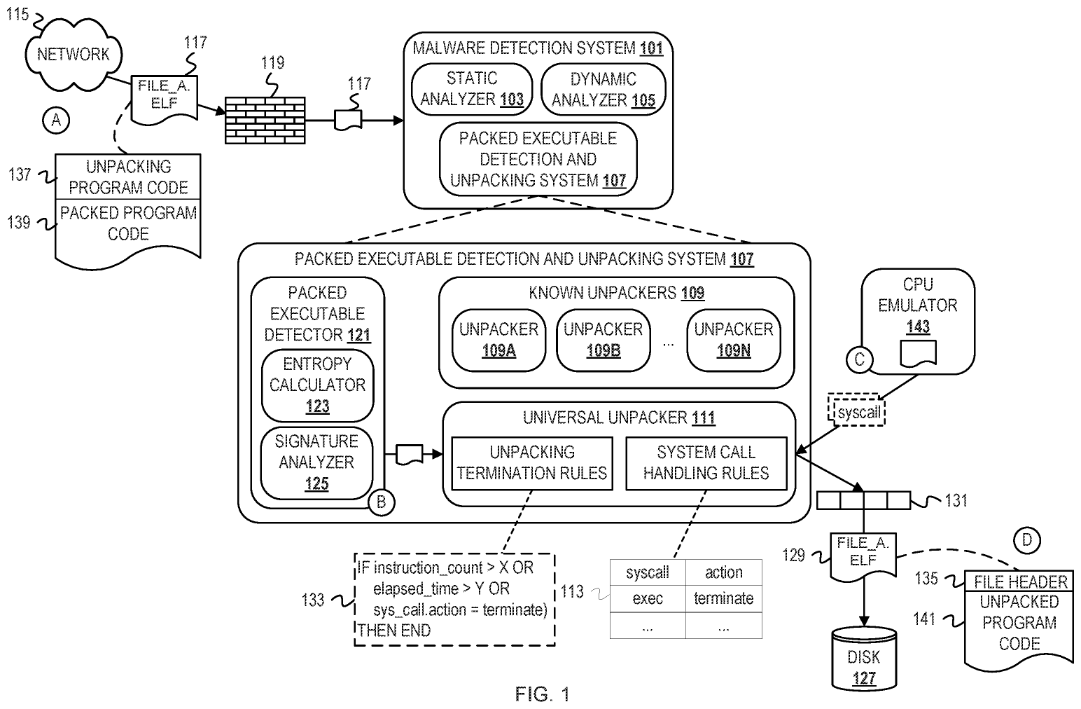

FIG. 1 depicts an example conceptual diagram of software packer-agnostic unpacking of executable files. FIG. 1 depicts a packed executable detection and unpacking system (“system”) 107 for detecting and subsequently unpacking packed executables that is part of a malware detection system 101 (e.g., can be implemented as a service offered by the malware detection system 101). The unpacking system 107 includes a packed executable detector 121, known unpackers 109, and a universal unpacker 111. The packed executable detector 121 facilitates detection of packed executable files. The known unpackers 109 can be leveraged to unpack executables for which the software packer/packing technique which was utilized can be determined. The universal unpacker 111 can be leveraged to unpack executables for which the software packer/packing technique which was utilized cannot be determined. The universal unpacker 111 is referred to as “universal” because it can be utilized to unpack executables packed with any software packer/packing technique; that is, the universal unpacker 111 is agnostic to the technique which was used to pack an executable being unpacked. The malware detection system 101 also includes a static analyzer 103 and a dynamic analyzer 105 for performing malware analysis of software samples (hereinafter “samples”) detected by a firewall 119. Although the unpacking system 107 is depicted as part of the malware detection system 101, in other implementations, the unpacking system 107 can be implemented separately from the malware detection system 101.

FIG. 1 is annotated with a series of letters A-D. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

At stage A, the firewall 119 detects an executable file 117 and forwards the executable file 117 to the unpacking system 107. The firewall 119 monitors and controls network traffic incoming from a network 115 (e.g., a public network). While monitoring incoming network traffic, the firewall 119 detects the executable file 117. In this example, the executable file 117 is an ELF file that has been packed. The executable file 117 includes packed program code 139 of the executable and unpacking program code 137, where the unpacking program code 137 unpacks the packed program code 139 to expand the program code/data of the executable in memory upon execution. The firewall 119 communicates the executable file 117 to the malware detection system 101 for malware analysis. The firewall 119 may be configured to communicate samples detected from incoming network traffic to the malware detection system 101 via a firewall rule or policy.

At stage B, the unpacking system 107 determines if the executable file 117 has been packed. Based on determining that the detected sample forwarded from the firewall 119 is an executable, the malware detection system 101 can invoke the unpacking system 107 to determine whether the executable has been packed. The unpacking system 107 can determine if the executable file 117 has been packed based on calculating entropy of the executable file 117 and/or scanning the executable file 117 for signatures indicative that the executable file 117 has been packed by invoking an entropy calculator 123 and a signature analyzer 125, respectively. The entropy calculator 123 calculates an entropy of the executable file 117 and can determine if the executable file 117 is packed based on whether the calculated entropy exceeds a threshold. Alternatively or in addition, the signature analyzer 125 can evaluate a signature of the executable file 117 against one or more signatures associated with known software packers/packing techniques. If the signature analyzer 125 identifies a match between a signature of the executable file 117 and a signature of a known packer/packing technique, the packed executable detector 121 can determine that the executable file 117 has been packed with a known packer/technique and pass the executable file 117 to a respective one of the known unpackers 109 to be unpacked. In this example, the packed executable detector 121 determines that the executable file 117 has been packed with an unknown technique based on the calculated entropy exceeding a threshold and/or the signature analyzer 125 failing to identify a match and passes the executable file 117 to the universal unpacker 111.

At stage C, the universal unpacker 111 unpacks the executable file 117 by executing the unpacking program code 137 of the executable file 117 in a controlled environment. The controlled environment is a CPU emulator 143 in this example, although other implementations of the controlled environment may be used (e.g., sandboxes). The universal unpacker 111 loads the executable file 117 into the CPU emulator 143 and executes the unpacking program code 137 with the CPU emulator 143. The CPU emulator 143 can instrument program code of the executable file 117 upon load to allow for interception of system calls that are identified in system call handling rules 113 maintained by the universal unpacker 111 (e.g., through insertion of code hooks). The execution of the unpacking program code 137 unpacks the packed program code 139 into memory 131. During execution, the universal unpacker 111 intercepts the instrumented system calls and determines how to handle the system calls based on the system call handling rules 113. The system call handling rules 113 comprise system calls which may be intercepted and a corresponding action to take upon interception of the system call. Actions can include allowing a system call, emulating a system call, or terminating execution based on interception of a system call. System call emulation allows for protection of the host system on which the unpacking system 107 runs without hindering unpacking of packed executables. The universal unpacker 111 monitors unpacking of the packed program code 139 into memory 131 and intercepts system calls until a first of unpacking termination rules 133, which indicate events or conditions which should trigger termination of execution of a packed executable, has been satisfied. In this example, the unpacking termination rules 133 denote that unpacking should be terminated if a count of executed instructions exceeds a maximum value, if an elapsed time of execution exceeds a maximum time, or if an intercepted system call should trigger termination based on its action designated in the system call handling rules 113. For example, as indicated by the unpacking termination rules 133 and the system call handling rules 113, the universal unpacker 111 can terminate unpacking based on identifying that the system call “exec” has been intercepted.

At stage D, the universal unpacker 111 writes the memory 131 which comprises an unpacked version of the packed program code 139 of the executable file 117, or unpacked executable file 129, to disk 127. Unpacking/expansion of the packed program code 139 of the executable file 117 into memory 131 generates unpacked program code 141. The corresponding portion of the memory 131 thus comprises unpacked program code/data of which the unpacked executable file 129 is comprised. The universal unpacker 111 can create a memory dump to write the memory 131 to the disk 127. The universal unpacker 111 also creates a file header 135 for the unpacked executable file 129 based on its file type. In this example, the file header 135 created by the universal unpacker 111 is an ELF header. As a result of writing the unpacked executable file 129 to the disk 127, the malware detection system 101 can access the unpacked executable file 129 for malware analysis. The static analyzer 103 and dynamic analyzer 105 can subsequently perform a static analysis and dynamic analysis, respectively, on the unpacked executable file 129 to determine if the file 129 comprises malware.

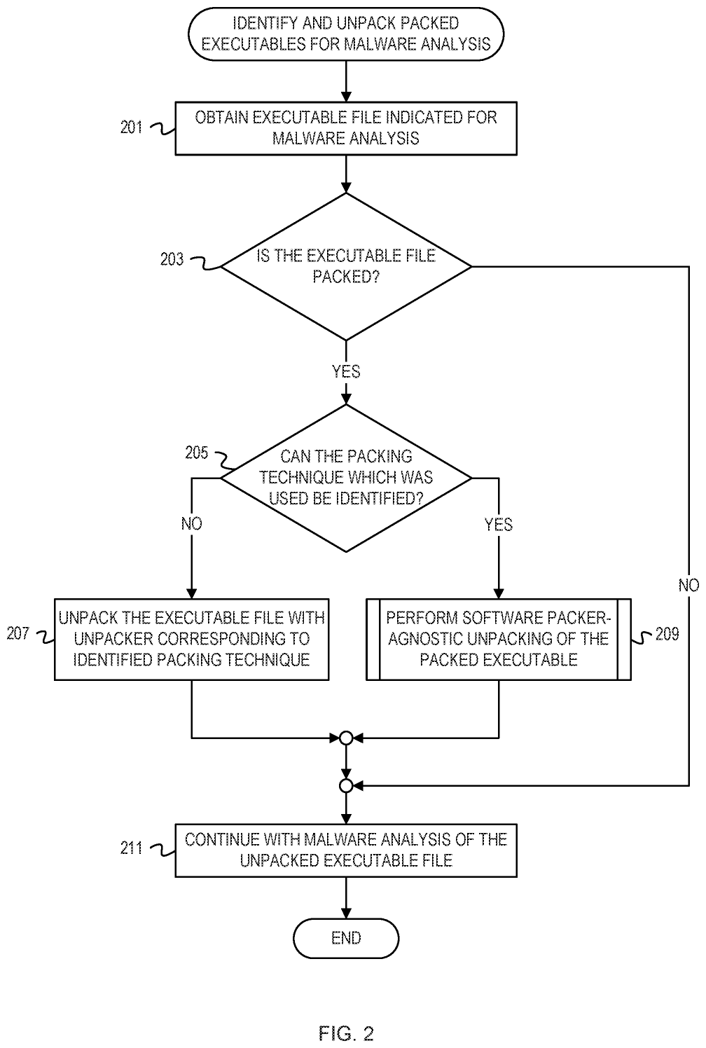

FIGS. 2-5 depict example operations for software-agnostic unpacking of packed executables. The example operations are described with reference to a packed executable detection and unpacking system (hereinafter simply “unpacking system”) for consistency with FIG. 1. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 depicts a flowchart of example operations for identifying and unpacking packed executables for malware analysis. Unpacking of packed executables indicated for malware analysis generates a format of the executable that is at least partially unpacked and therefore compatible with malware analysis, including static analysis and/or dynamic analysis.

At block 201, the unpacking system obtains an executable file indicated for malware analysis. The executable file may have been detected by a firewall which monitors incoming network traffic and communicated to the unpacking system. The executable file may be a PE file, an ELF file, etc.

At block 203, the unpacking system determines if the executable file has been packed. The unpacking system can calculate entropy of the executable file and evaluate the calculated entropy against a threshold. The unpacking system then determines if the executable file has been packed based on whether the calculated entropy exceeds the threshold. As another example, the unpacking system can scan a signature of the executable file for signatures known to be associated with packed executables alternatively or in addition to calculating entropy. The unpacking system then determines if the executable file has been packed based on whether the signature of the executable file matches a signature known to be associated with packed executables (e.g., based on signatures associated with known software packers and/or packing techniques). In some implementations, the unpacking system may attempt to perform static analysis of the executable file and inspect results of the static analysis to determine whether the results indicate that the executable file has been packed (e.g., if the static analysis produces incomplete results). If the unpacking system determines that the executable file has been packed, operations continue at block 205. If the unpacking system determines that the executable file has not been packed, operations continue at block 211.

At block 205, the unpacking system determines if the software packer or packing technique which was used to pack the executable file can be identified. The unpacking system can evaluate a signature of the executable file against one or more signatures associated with known packing techniques or software packers through signature scanning. The packing technique can be identified if the signature of the executable file matches a signature of a known packing technique or software packer. The unpacking system may utilize results of operations performed at block 203 if the executable file was previously determined to be packed based at least partly on signature scanning. If the software packer/packing technique can be identified, operations continue at block 207. If the software packer/packing technique cannot be identified, operations continue at block 209.

At block 207, the unpacking system unpacks the executable file using an unpacker which corresponds to the identified software packer or packing technique. The unpacking system can maintain or have access to one or more software unpackers, each of which corresponds to a respective one of the signatures associated with known software packers/packing techniques. The unpacking system identifies the unpacker which corresponds to the packing technique or software packer determined to have been used to pack the executable file, unpacks the executable file with the identified unpacker, and writes the unpacked executable file to disk storage.

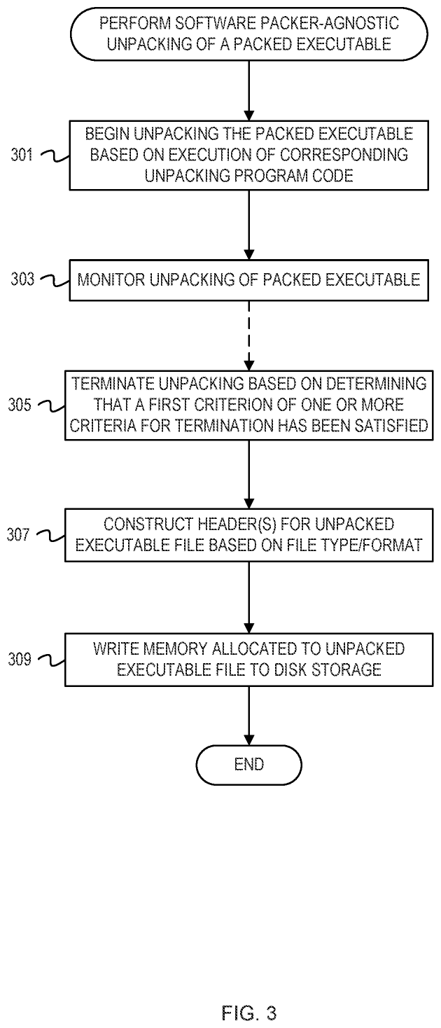

At block 209, the unpacking system performs software-packer agnostic unpacking of the executable file. The unpacking system can execute unpacking program code of the executable file in a controlled environment, such as by loading binary code of the executable file in a CPU emulator to emulate its execution, and intercept system calls issued during execution. Execution of the unpacking program code of the executable file unpacks the packed program code/data of the executable file into memory. Unpacking (i.e., execution of the unpacking program code) can be terminated upon determining that a criterion for termination has been satisfied. Criteria for termination can include a maximum elapsed time, a maximum number of executed instructions, or interception of a system call that is indicated to be forbidden or dangerous to the host system has been issued (e.g., exec). The unpacking system then creates a header for the unpacked executable file based on its type/file format and can write the memory which comprises the unpacked executable file to disk storage. Software-packer agnostic unpacking of packed executable files is described in additional detail in reference to FIG. 3.

At block 211, malware analysis of the unpacked executable file is performed. For instance, the unpacking system may communicate a notification to a malware detection service indicating that the executable file has been unpacked and is ready for static analysis and/or dynamic analysis. As another example, if the unpacking system is implemented as part of a malware detection service, the malware detection service can retrieve the unpacked executable file for malware analysis.

FIG. 3 depicts a flowchart of example operations for performing software packer-agnostic unpacking of a packed executable. The description of FIG. 3 assumes that an executable file has already been detected and determined to be packed. The executable file comprises packed data (e.g., program code) of the executable and unpacking program code which can be executed to unpack the executable.

At block 301, the unpacking system begins unpacking the packed executable based on executing the corresponding unpacking program code. The unpacking system may execute the unpacking program code via a CPU emulator. For instance, the unpacking system can load binary code of the executable file in a CPU emulator and apply instrumentation such as code hooks to allow for interception of system calls. The unpacking system may maintain policies, rules, etc. which indicate system calls for which to monitor and apply the instrumentation accordingly. Execution of the unpacking program code unpacks/expands the packed data of the executable into memory allocated for the unpacked data.

At block 303, the unpacking system monitors unpacking of the packed executable. The unpacking system monitors memory allocated during unpacking of the packed executable. As part of monitoring unpacking, the system intercepts system calls and determines whether to allow, emulate, or block the intercepted system calls. The rules or policies indicating system calls for which to monitor may also indicate corresponding actions to take upon interception of each indicated system call. Upon interception of a system call, the system determines the action which should be taken for handling the system call (e.g., based on the rules or policies) and allows, blocks, or emulates the system call accordingly. System calls which should be blocked may also trigger termination of unpacking as a result of being determined potentially harmful to the host system on which the unpacking system executes (e.g., exec). Allowing or emulating the remaining system calls facilitates unhindered self-unpacking of the executable.

At block 305, the unpacking system terminates unpacking of the packed executable based on determining that a first criterion of one or more criteria for termination has been satisfied. Monitoring of unpacking can be ongoing until the unpacking system determines that a criterion for terminating unpacking has been satisfied. Examples of the criteria include an execution time threshold, an instruction count threshold, and interception of a system call that should be blocked as described at block 303. As an example, the unpacking system can terminate unpacking if the elapsed time satisfies the execution time threshold, the number of instructions which have been executed satisfies the instruction count threshold, or if the system intercepts a system call which it determines should be blocked based on the rules or policies for handling system calls.

At block 307, the unpacking system constructs a header(s) for the unpacked executable file based on its file type/format. The executable file which results upon termination of unpacking comprises a version of the packed executable that is at least partially unpacked (hereinafter the “unpacked executable” for simplicity). The unpacking system constructs the header(s) for the unpacked executable to generate a format of the unpacked executable which comports with the standard file format for its respective type. For instance, the unpacking system can construct an ELF header for the unpacked executable if the executable file is an ELF file.

At block 309, the unpacking system writes the memory allocated to the unpacked executable file to disk storage. As the packed data is unpacked during execution of the unpacking program code, memory is allocated for the unpacked data of the executable. The memory allocated during unpacking thus comprises the unpacked executable. The unpacking system writes this memory which comprises the unpacked executable to disk storage (e.g., via creation of a memory dump). The unpacked executable can subsequently be accessed from disk storage for malware analysis.

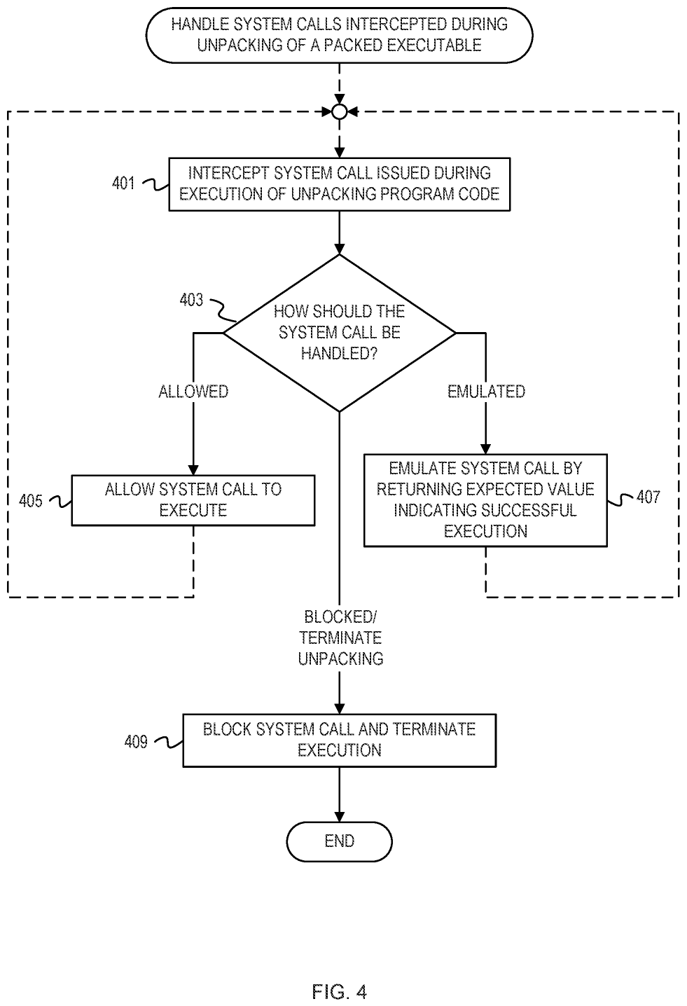

FIG. 4 depicts a flowchart of example operations for handling system calls intercepted during unpacking of a packed executable. The example operations assume that unpacking of an executable file that comprises packed data of an executable and corresponding unpacking program code has begun as described in reference to FIG. 3.

At block 401, while monitoring unpacking of a packed executable, the unpacking system intercepts a system call issued during execution of the unpacking program code. At block 403, the unpacking system determines how the system call should be handled. The unpacking system can maintain or have access to rules or policies which indicates system calls that may be intercepted, such as based on instrumentation via a CPU emulator, and corresponding actions for handling the system calls upon interception. For instance, for each indicated system call, the rules or policies can denote whether the unpacking system should allow the system call to execute, emulate the system call, or block the system call and subsequently terminate unpacking. The unpacking system can determine the action to take for handling the system call based on the rule or policy corresponding to the intercepted system call. If the system call should be allowed, operations continue at block 405. If the system call should be emulated, operations continue at block 407. If the system call should be blocked and trigger termination of unpacking, operations continue at block 409.

At block 405, the unpacking system allows the system call to execute. The unpacking system allows the system call to execute without interference with expected behavior which results. Operations continue at block 401, where the unpacking system continues to monitor unpacking of the packed executable.

At block 407, the unpacking system emulates the system call based partly on returning an expected value indicating successful execution of the system call. The rule or policy identified at block 403 may also indicate a value which should be returned based on interception of the system call, where the indicated value corresponds to a value that would be expected in response to successful execution of the system call. The unpacking system blocks execution of the system call and returns the indicated value corresponding to successful execution. Emulating system calls allows unpacking to proceed as if the system call executed as expected while also preventing harm or other impact to the host system that may result from actual execution of the system call. Operations continue at block 401, where the unpacking system continues to monitor unpacking of the packed executable.

At block 409, the unpacking system blocks the system call and terminates execution of the unpacking program code. The unpacking system can also write the portion of memory which comprises the at least partially unpacked executable to disk upon termination of execution. Operations continue at block 401, where the unpacking system continues to monitor unpacking of the packed executable.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 203 and 205 can be performed at least partially in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

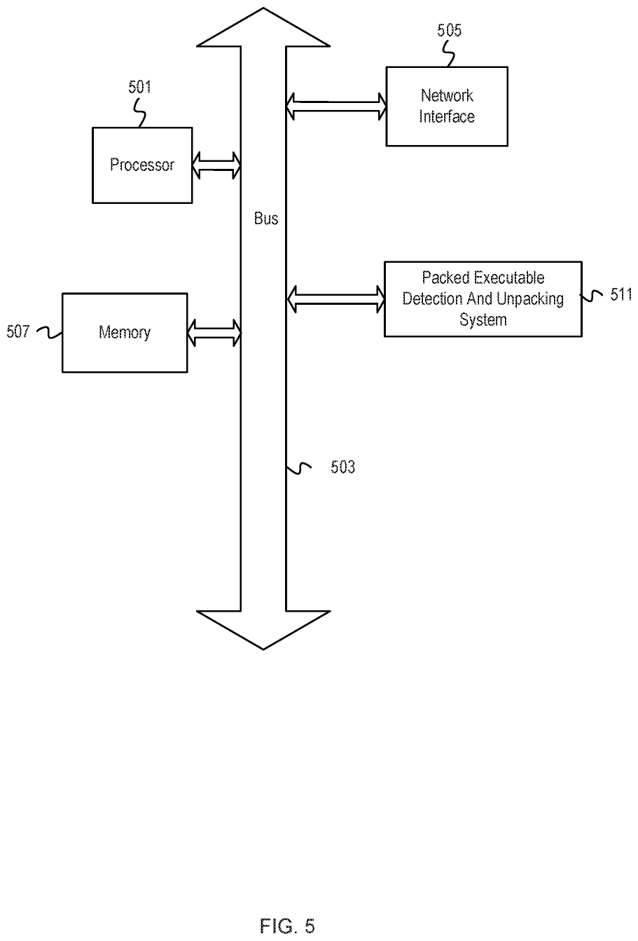

FIG. 5 depicts an example computer system with a packed executable detection and unpacking system. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes packed executable detection and unpacking system 511. The packed executable detection and unpacking system 511 detects and unpacks executable files which have been packed to generate an unpacked version of the executable file that is compatible with malware analysis techniques (e.g., static analysis). Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

While the aspects of the disclosure are described with reference to various implementations and exploitations, it will be understood that these aspects are illustrative and that the scope of the claims is not limited to them. In general, techniques for software packer-agnostic unpacking of packed executables as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
determining that an executable indicated for malware analysis has been packed, wherein the executable comprises packed data of the executable and unpacking program code;
determining if a software packer or packing technique with which the executable was packed can be identified,
based on determining that the software packer or packing technique with which the executable was packed cannot be identified, executing the executable to at least partially unpack the packed data into an unpacked version of the executable;
monitoring execution of the executable based, at least in part, on intercepting system calls issued during execution; and
terminating execution of the executable based, at least in part, on determining that a first criterion of one or more criteria for terminating execution has been satisfied.

2. The method of claim 1, further comprising indicating that malware analysis of the unpacked version of the executable can be performed based, at least in part, on terminating execution of the executable.

3. The method of claim 1, wherein determining if the software packer or packing technique can be identified comprises comparing a signature of the executable with a plurality of signatures, wherein each of the plurality of signatures corresponds to a known packer or packing technique.

4. The method of claim 3 further comprising,
determining that the software packer or packing technique can be identified based, at least in part, on identifying a match between the signature of the executable and a first signature of the plurality of signatures; and
unpacking the executable with a known software packer or packing technique which corresponds to the first signature.

5. The method of claim 1, wherein the one or more criteria for terminating execution comprise at least one of a maximum time of execution, a maximum number of instructions that are executed, and one or more system calls that trigger termination of execution.

6. The method of claim 1 further comprising calculating entropy of the executable, wherein determining that the executable has been packed comprises determining that the calculated entropy exceeds a threshold.

7. The method of claim 1, wherein executing the executable comprises executing the unpacking program code of the executable with a central processing unit (CPU) emulator.

8. The method of claim 1 further comprising, based on intercepting a first system call, determining if execution of the first system call should be allowed, emulated, or blocked.

9. The method of claim 8 further comprising,
based on determining that execution of the first system call should be allowed, allowing the first system call to execute;
based on determining that execution of the first system call should be emulated, blocking execution of the first system call and returning a value corresponding to successful execution of the first system call; and
based on determining that the first system call should be blocked, block execution of the first system call.

10. The method of claim 9 further comprising terminating execution of the unpacking program code based, at least in part, on blocking execution of the first system call.

11. The method of claim 1 further comprising writing memory allocated to the executable to disk, wherein the memory written to the disk comprises the unpacked version of the executable.

12. The method of claim 11 further comprising constructing a header for the unpacked version of the executable based, at least in part, on a type of the executable.

13. One or more non-transitory machine-readable media comprising program code to:
determine whether a known software packer can be identified to unpack an executable file that comprises a packed executable and unpacking program code;
based on a determination that a known software packer cannot be identified to unpack the executable file, unpack from the executable file the packed executable into memory based, at least in part, on execution of the unpacking program code in a controlled environment;
monitor unpacking of the packed executable based, at least in part, on monitoring system calls issued during execution of the unpacking program code; and
based on termination of execution of the unpacking program code, write the memory to disk storage, wherein the memory comprises an unpacked version of the packed executable.

14. The non-transitory machine-readable media of claim 13, wherein the program code to determine whether a known software packer can be identified comprises program code to determine whether a signature associated with the executable file matches a first of a plurality of signatures associated with corresponding ones of a plurality of known software packers.

15. The non-transitory machine-readable media of claim 13 further comprising program code to terminate execution of the unpacking program code based on a determination that a criterion for termination has been satisfied, wherein the criterion comprises a maximum elapsed time of execution, a maximum count of executed instructions, and interception of a first of one or more system calls that trigger termination.

16. An apparatus comprising:
a processor; and
a computer-readable medium having instructions stored thereon that are executable by the processor to cause the apparatus to,
based on a determination that an executable file comprises packed data and unpacking program code, determine if a software packer or packing technique with which the executable file was packed can be identified;
based on a determination that the software packer or packing technique cannot be identified, unpack the executable file in memory based, at least in part, on execution of the unpacking program code of the executable file in a controlled environment;
monitor execution of the unpacking program code based, at least in part, on interception of system calls issued during execution;
based on a determination that a criterion for termination of unpacking has been satisfied, terminate execution of the unpacking program code; and
indicate that malware analysis of the executable file can be performed.

17. The apparatus of claim 16, further comprising instructions executable by the processor to cause the apparatus to,
construct a header for the executable file based, at least in part, on a type of the executable file; and
write the memory to disk,
wherein the memory comprises an unpacked version of at least a subset of the packed data of the executable file,
and wherein the instructions executable by the processor to cause the apparatus to indicate that malware analysis of the executable file can be performed comprise instructions executable by the processor to cause the apparatus to indicate that malware analysis of the unpacked version of the subset of the packed data of the executable file can be performed.

18. The apparatus of claim 16, wherein the criterion for termination of unpacking comprises a maximum time of execution, a maximum count of executed instructions, or interception of a first system call of one or more system calls that trigger termination of execution.

19. The apparatus of claim 18, wherein the instructions executable by the processor to cause the apparatus to terminate execution of the unpacking program code comprise instructions executable by the processor to cause the apparatus to terminate execution based, at least in part, on a determination that a time of execution exceeds the maximum time, that a count of executed instructions exceeds the maximum count of instructions, or that an intercepted system call is indicated in the one or more system calls that trigger termination of execution.

20. The apparatus of claim 16, wherein the instructions executable by the processor to cause the apparatus to determine if the software packer or packing technique can be identified comprise instructions executable by the processor to cause the apparatus to compare a signature of the executable with a plurality of signatures, wherein each of the plurality of signatures corresponds to a known packer or packing technique.
